(19) United States
(12) Patent Application Publication
(10) Pub. No.: US 2024/0262067 A1
(43) Pub. Date: Aug. 8, 2024

(54) Sealing ring and method of production

(71) Applicant: Trelleborg Sealing Solutions, Stuttgart (DE)

(72) Inventors: Gert Mølsted Iversen, Heisingør (DK); Lars de Caldas Sondrup, Hillerød (DK)

(73) Assignee: Trelleborg Sealing Solutions, Stuttgart (DE)

(21) Appl. No.: 18/637,838

(22) Filed: Apr. 17, 2024

Related U.S. Application Data
(63) Continuation of application No. PCT/EP2022/080820, filed on Nov. 4, 2022.

(30) Foreign Application Priority Data
Nov. 4, 2021 (DE) DE 102021212442.9

(51) Int. Cl. B29D 99/00; F16J 15/3284

(52) U.S. Cl. CPC B29D 99/0085; F16J 15/3284; B29C 2793/0027

(57) ABSTRACT

A sealing ring for a sealing system in the form of a pneumatic or hydraulic system includes a peripherally arranged sealing edge for dynamically contacting a sealing surface of a machine part. The sealing edge is closed in a ring shape relative to the central axis of the sealing ring. The sealing ring in its unloaded state has, in a section comprising the central axis, a transverse axis which, with the central axis, encloses an angle α with 7°≤α≤90°. The sealing ring may be produced from a longitudinal profile.

### CROSS-REFERENCE TO RELATED APPLICATIONS

This continuation application claims priority to PCT/EP2022/080820 filed on Nov. 4, 2022, which has published as WO 2023/079077 A1, and also the German application number DE 10 2021 212 442.9 filed on Nov. 4, 2021, the entire contents of which are fully incorporated herein with these references.

### DESCRIPTION:

### Field of the Invention

The invention relates to a method for producing a sealing ring, and a sealing ring.

### Background of the Invention

Sealing systems are established in many industrial sectors and substantially comprise two machine parts, which are arranged at a distance from each other and which are movable relative to each other along and/or around a movement axis. In a hydraulic or pneumatic system, one of the machine parts is designed as a piston or a piston rod, and the respective other as a cylinder, in which the piston or the piston rod is movable back and forth. Formed between the two machine parts is a bearing or sealing gap, which is sealed off by means of at least one sealing ring. The sealing system can alternatively also have a machine part in the form of a shaft and a further machine part in the form of a housing engaging around the shaft. The sealing rings used usually have a sealing edge which, in their installed position, rests in a dynamically sealing manner on the sealing surface of one of the two machine parts and are normally designed as so-called radial sealing rings. To retain the sealing ring, use is made of a seal retaining structure, normally in the form of an annular groove, in or on which the sealing ring is retained. Generally, a preloading element, for example in the form of a rubber ring, is used to ensure adequate contact pressure between the sealing edge of the sealing ring and the sealing surface. The sealing ring can also be designed in the form of a so-called scraper or have a scraping function in order to counteract penetration or entrainment of water or dirt into the sealing system.

An aforementioned sealing system with sealing ring has been disclosed, for example, by US 2019 0107 203 A1 and US 5 082 295 A.

The known sealing rings are usually produced in the course of an injection molding process.

### SUMMARY OF THE INVENTION

It is the object of the invention to indicate a simplified and cost-effective method for producing a sealing ring with partly different material properties, and such a sealing ring.

The object relating to the method for producing the sealing ring is achieved by the methods specified in the first independent claim. The sealing ring according to the invention is specified in the second independent claim.

The method according to the invention is used to produce a sealing ring, in particular a radial sealing ring, and comprises the following method steps:

In a first step, a longitudinal profile in the form of a cylindrical tube or a cylindrical rod (solid profile) is provided.

In a further step, the radial sealing ring to be separated from the longitudinal profile is defined in the material of the longitudinal profile with a transverse axis of the radial shaft sealing ring extending at an acute angle α to the central axis of the longitudinal profile with 7°≤α≤90°. In other words, the sealing ring—when viewing a longitudinal section of the longitudinal profile—is defined in the material of the longitudinal profile with a transverse axis extending obliquely relative to the inner peripheral side of the longitudinal profile. As a result, the sealing ring has an external contour which tapers in the direction of the central axis toward the high-pressure side of the sealing ring.

In a following step, the sealing ring is separated from the longitudinal profile in the course of a material-removing process. Conventional machine tools can be used for this purpose.

Radial sealing rings are frequently asymmetrical and have an inflow side facing the high-pressure side H and an outflow side facing away from the high-pressure side H or, in scraper rings, a side in the direction of the surroundings. Such radial sealing rings often require different properties over the axial width of the sealing surface. Thus, radial sealing rings for high-pressure applications, for example, require increased mechanical strength on the downstream side, i.e., low-pressure side. In a corresponding manner, in a scraper an increased material hardness relative to the surroundings is required. Current designs, even if they are fabricated from hybrid materials with concentric layers, do not meet such requirements in one part and accordingly frequently have to comprise additional parts such as corner reinforcements or supporting rings for this purpose, which increases the complexity and the fabrication costs.

According to the invention, to this extent a multicomponent or hybrid longitudinal profile having two or more concentric material layers is used as the longitudinal profile, said material layers differing from one another in their material properties, for example their mechanical, chemical or electrical properties and also with regard to their costs or their external appearance. In this regard, in particular longitudinal profiles made of a hybrid material with concentric layers of different PTFE (polytetrafluoroethylene) compounds, PTFE/PEEK (=polyether ether ketone) layers or and PU (polyurethane) layers are suitable.

With the present invention, when a multicomponent longitudinal profile is used, it is consequently made possible to position specific material layers at different axial positions of the sealing ring. As a result, it becomes possible to produce parts with different optical, mechanical, electrical or chemical or other material properties over the axial extent of the sealing ring (based on its central axis). On the basis of the example of a radial sealing ring to be used as a piston rod seal, it is for example possible to provide the sealing section or the sealing edge on the low-pressure side facing away from the sealing with a mechanically load-bearing material while, in the axial center of the sealing section, there is a softer material with better sealing properties and, if appropriate, a further material on the high-pressure side of the radial sealing ring, for example in order to reduce material costs or to improve the installation. Similar advantages can be achieved in other radial seals, radial shaft sealing rings and scrapers or the like.

The sealing ring produced by the method according to the invention is in particular intended for hydraulic or pneumatic applications, i.e., for a pneumatic or hydraulic system, or as a radial shaft sealing ring. To this end, the sealing ring has a preferably peripherally arranged sealing edge for dynamically sealingly contacting a sealing surface of a machine part. The sealing edge is designed to be closed in a ring shape relative to the central axis of the sealing ring. The sealing ring can in particular be designed to be internally or externally sealing. According to the invention, the sealing ring in its unloaded state has, in a cross section comprising the central axis, a transverse axis which forms with its central axis an acute angle α with 7°≤α≤90°. The transverse axis here is that axis of the sealing ring which, in the aforesaid cross section of the sealing ring, is aligned so as to extend from the low-pressure to the high-pressure side and which, in the installed state of the sealing ring, is aligned so as to extend parallel or substantially parallel to the sealing surface or the movement axis of the machine parts of the sealing system that are to be sealed off relative to each other. The transverse axis can, in particular, be arranged to extend orthogonally to one or to both side flanks of the sealing ring. The sealing ring according to the invention in the unloaded state consequently has an internal cross section which decreases from the low-pressure side to the high-pressure side of the sealing ring. For its installation, the sealing ring thus has to be deformed more highly on the high-pressure side (i.e., widened more highly in the case of an internally sealing ring or compressed more highly in the case of an externally sealing ring) than on the low-pressure side. As a result, in the installation or mounting state, the compression (over its periphery) changes over the entire axial width of the sealing ring. In the mounting or installation state of the sealing ring, this can be used to improve the distribution of the contact pressing pressure of the sealing ring against the sealing surface (mating running surface) and, at the same time, to improve the resistance with respect to high operating pressures on the high-pressure side H, by reducing the loading of the low-pressure side end segment of the sealing ring.

The sealing ring according to the invention can be produced in a simple and cost-effective way and does not require any special tools during its fabrication.

According to the invention, the sealing ring can, in particular, be designed as a radial sealing ring. The radial sealing ring can have a supporting structure which, on the high-pressure side H of the sealing edge, is arranged at a distance from the sealing edge in an axial direction relative to the central axis of the sealing ring. As a result, firstly during the installation of the sealing system, in which the parts to be sealed off with respect to each other are pushed into each other, a first impact on the radial sealing ring of the machine part of the sealing system having the sealing surface can be absorbed. In addition, during the mounting, centering of the radial sealing ring relative to the movement axis of the machine parts of the sealing system that are to be sealed off relative to each other can be achieved by the supporting structure. As a result, the sealing edge can be contacted peripherally during contact with the relevant machine part. This offers the advantage of particularly gentle mounting for the sealing edge of the radial sealing ring. Undesired structural overloading of the sealing edge and associated premature wear or premature functional failure of the radial sealing ring can be counteracted as a result. Furthermore, the radial sealing ring, for example in its radially internally sealing design, during the axial introduction on the high-pressure side of the machine part having the sealing surface into the radial sealing ring over the supporting structure supported on this machine part—prior to contacting the sealing edge—can have a moment applied by means of which the radial sealing ring is firstly rotated or pivoted into or in the direction of its predefined mounting position within/on a seal retaining structure.

It is important for the sealing performance of the radial sealing ring that the supporting structure does not impair the sealing function in operation and does not restrict the access of fluid flow or pressure to the sealing surface. Accordingly, the supporting structure can be provided with notches running axially. During the operational use of the radial sealing ring, the supporting structure preferably does not bear on the sealing surface, is therefore arranged at a distance therefrom.

According to the invention, the supporting structure can, for example, be formed by an annular bead or by a plurality of radial protrusions of the radial sealing ring spaced apart from one another in the peripheral direction of the radial sealing ring, or by an edge of the radial sealing ring which is formed by an installation-opening-side or high-pressure side end face/side flank of the sealing ring and the peripheral surface of the sealing ring which has the sealing edge.

According to a particularly preferred development, the radial sealing ring has a peripheral side or lateral surface which faces away from the sealing edge and which, in the mounting state of the sealing ring in which pressure is applied, is designed to be at least partly cylindrical. As a result, large-area support of a preloading ring clamping in the radial direction is made possible, by which the sealing edge of the radial sealing ring (in the installed state) can be clamped against the sealing surface of the one machine part in a radial direction relative to the central axis of the radial sealing ring. According to an alternative embodiment, the peripheral side can be shaped concavely or curved convexly outward in the longitudinal direction of the radial sealing ring.

Particularly preferably, the sealing ring has end faces extending parallel to each other. As a result, particularly simple fabrication and a wide range of uses of the sealing ring are made possible.

The sealing ring is designed as a multicomponent part, in particular, as a two- or three-component part. As a result, the sealing ring can have different material properties in/on different sections, corresponding to the requirement. Thus, the material of the sealing ring in the region of the sealing edge can for example be visco-plastic and otherwise elastomeric and vice versa. Furthermore, the sealing ring can have reinforcing regions, by means of which the mechanical stability of the sealing ring with respect to deformation is increased locally. If the sealing ring is designed as a multicomponent part, then each dividing line between the material layers of the sealing ring in the unloaded state of the sealing ring is arranged to extend parallel to the central axis of the sealing ring. In the installed state of the sealing ring, each dividing line encloses with the central axis or with the movement axis of the machine parts to be sealed off relative to each other the previously explained angle α or substantially the previously explained acute angle α with 7°≤α≤90°.

According to a development of the invention, the sealing ring is formed from one or more plastics which differ from one another in their material properties. At least one of the plastics can be, for example, an elastomer.

Further advantages of the invention can be gathered from the description and the drawing. The invention is explained in more detail below with reference to exemplary embodiments reproduced in the drawing. The embodiments shown and described are not to be understood as an exhaustive list, but instead have an exemplary character for the depiction of the invention.

### BRIEF DESCRIPTION OF THE DRAWINGS

In the drawings:

FIG. 1 shows a longitudinal profile in a detail of a longitudinal section, with exemplary contours of sealing rings to be produced from the longitudinal profile, wherein their contours in the longitudinal profile are defined in the conventional way (prior art);

FIG. 2 shows a longitudinal profile in a detail of a longitudinal section, with exemplary contours of sealing rings to be produced from the longitudinal profile, wherein their contours in the longitudinal profile are defined in the way according to the invention;

FIG. 3 shows a block diagram with individual method steps of the method according to the invention for producing the sealing ring according to FIGS. 1 to 5;

FIGS. 4A-E shows a sealing system comprising a sealing ring in a chronological sequence of individual mounting steps of the sealing system, namely when introducing a first machine part into the second machine part, in the seal retaining structure of which the sealing ring is partly pre-installed (FIG. 4A); during first-time contact of the first machine part with the partly installed sealing ring (FIG. 4B); as the sealing ring is pivoted radially counter to the elastic restoring forces inherent to the seal, and during the first-time contacting of the sealing edge (FIG. 4C); as the sealing ring is pivoted further into the seal retaining structure (FIG. 4D); and when the sealing surface is contacted by the sealing edge in the non-pressure-loaded mounting state;

FIG. 5 shows the sealing system according to FIG. 4 when the high-pressure side is loaded with an operating pressure P below the maximum operating pressure Pₘₐₓ;

FIG. 6 shows the sealing system according to FIG. 4 when the high-pressure side is loaded with a maximum operating pressure Pₘₐₓ;

FIGS. 7A-B show a sealing ring of two-component design in a cropped sectional view (FIG. 7A) and in the operationally ready installed state (FIG. 7B);

FIGS. 8A-B shows a sealing ring of two-component design in a cropped sectional view (FIG. 8A) and in the operationally ready installed state (FIG. 8B); and

FIGS. 9A-B show a radial sealing ring in the form of a scraper of three-component design in a cropped sectional view (FIG. 9A) and in the operationally ready installed state (FIG. 9B).

### DETAILED DESCRIPTION OF EMBODIMENTS OF THE INVENTION

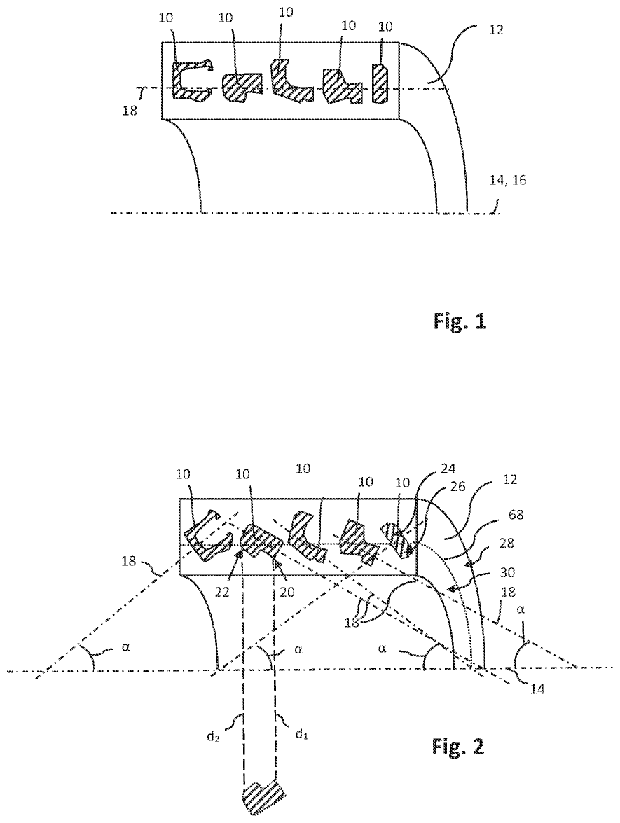

In the prior art, sealing rings and, specifically, also so-called scrapers, which are assigned to the radial sealing rings, are usually produced in the injection molding process or from a longitudinal profile in the course of a material-removing fabrication process. According to the illustration, as a rule cylindrical tubes and less frequently rods (solid profiles) are used as the longitudinal profile. According to the conventional fabrication method of the sealing rings, the sealing ring to be fabricated is defined in the material of the longitudinal profile. In the sectional illustration according to FIG. 1, the exemplary contours of different sealing rings 10, radial sealing rings here merely by way of example, are shown in the material of such a tubular longitudinal profile 12. The mid-axis 14 of the longitudinal profile 12 coincides with the central axis 16 of the sealing rings 10 respectively to be fabricated therefrom. The respective transverse axis 18 of the sealing rings 10 to be fabricated are all aligned so as to run strictly parallel or substantially parallel to the central axis 16 and to the mid-axis 14 of the longitudinal profile 12.

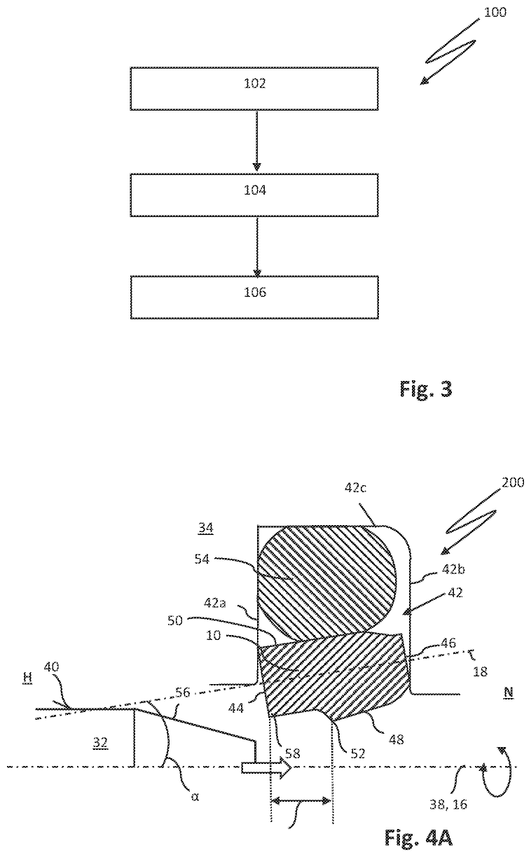

The fabrication of sealing rings 10 according to the invention, including radial sealing rings and scrapers, is explained below in conjunction with FIGS. 2 and 3. FIG. 2 shows, in a manner corresponding to FIG. 1, a longitudinal profile 12 in a sectional illustration with the contours of individual sealing rings 10 to be fabricated from the longitudinal profile 12 according to the method of the invention. FIG. 3 shows a block diagram with individual method steps of the method 100 according to the invention.

According to the method 100 according to the invention, a longitudinal profile 12 is provided in a first step 102. The longitudinal profile 12 can be designed as a cylindrical tube or as a cylindrical rod (in particular, made of solid material). In a further step 104, the respective sealing ring 10 to be fabricated is defined in the material of the longitudinal profile 12, as is shown in FIG. 2 by using the exemplary contours of different sealing rings 10, here radial sealing rings merely by way of example. The sealing rings 10 to be fabricated are arranged and defined with their transverse axes illustrated in FIG. 2 arranged to be tilted at an angle α to the mid-axis 14 of the longitudinal profile 12 and to the central axis 16 of the respective sealing ring 10 to be produced. The magnitude of the angle α is in principle greater than 7°. The magnitude of the angle α can, in particular, be between 11° and 90°.

In a further step 106, the sealing ring 10 or the sealing rings 10 is/are cropped (separated) or machined out of the longitudinal profile 12 in the course of a material-removing process. For this purpose, the material-removing fabrication methods and machine tools established in seal production in the prior art can be used. To this extent, in practice costly new investment is rendered superfluous.

According to FIG. 2, the sealing rings 10 produced according to the method 100 of the invention, as compared with the sealing rings 10 known from the prior art (FIG. 1), have a different internal diameter d₁, d₂ in the region of their respective axial end 20 on the high-pressure side and their axial end 22 on the low-pressure side. If the sealing ring 10 is installed in a seal retaining structure, in particular a (rectangular) groove in a machine part, then this is intrinsically possible only with torsion of the sealing ring 10. In other words, during its installation, a moment must be exerted on the sealing ring.

It should be noted that a multicomponent, for example a two-component, longitudinal profile 12, can be used as a longitudinal profile 12. Such a longitudinal profile 12 has a multi-layered structure. Thus, sealing rings having radial or axial segments 24, 26 which differ from one another in their material characteristics can be produced from the multicomponent longitudinal profile 12. Here, the individual components or (material) layers 28, 30 of the longitudinal profile 12 shown are arranged coaxially to the mid-axis 14 of the longitudinal profile 12 and permanently connected to one another. Consequently, these cannot be separated from one another without destroying the longitudinal profile 12; it is obvious that the longitudinal profile 12 can also have more than the two (material) layers shown.

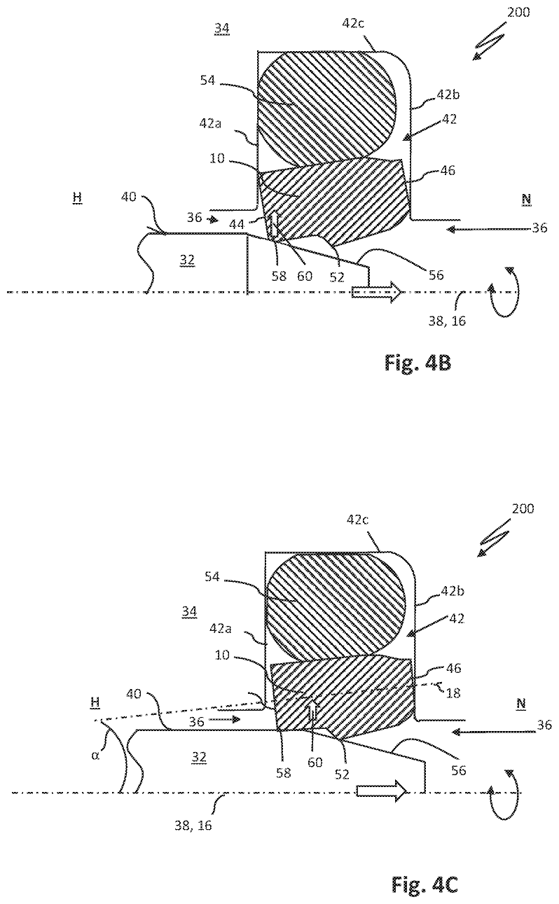

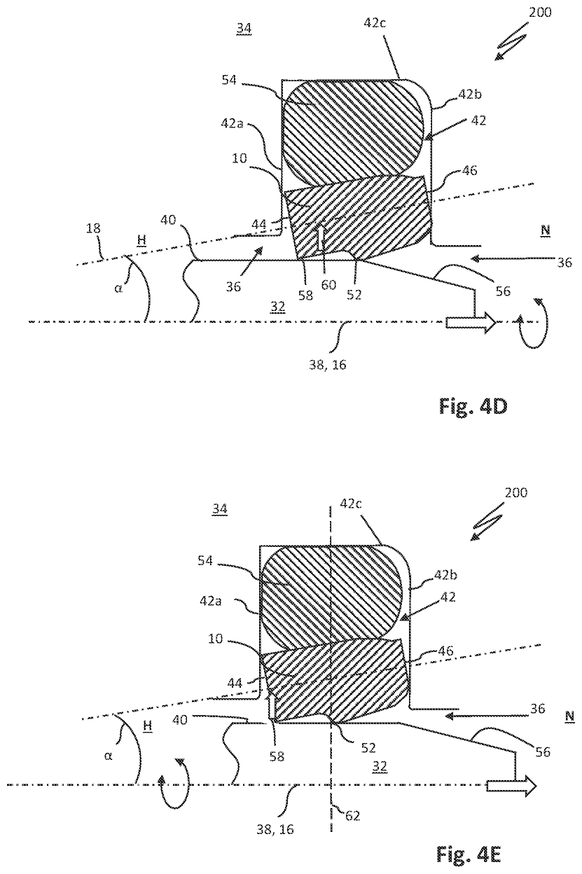

FIGS. 4 show the installation of a sealing system 200 having a sealing ring 10, here with an internally sealing radial sealing ring by way of example, at successive points in time. The sealing system 200 can, for example, be a pneumatic or hydraulic system.

The sealing system 200 comprises a first machine part 32 and a second machine part 34 which, in the mounting state, are spaced apart from each other, forming a sealing gap 36, and are arranged so as to be movable relative to each other along and/or around a movement axis 38.

The first machine part 32 can be, for example, a piston rod. The second machine part can be, for example, a cylinder. The first machine part 32 has a sealing surface 40, and the other machine part 34 has a seal retaining structure 42. To seal off a high-pressure side H of the system 200 or the sealing gap 36, a sealing ring 10 is used. The sealing ring 10 in the mounting state of the system 200 is arranged to be retained in the seal retaining structure 42, here in the form of an annular groove of rectangular cross section (=rectangular groove). The sealing ring 10 has a high-pressure first and a low-pressure second end face 44, 46. The inner peripheral side of the sealing ring 10 is designated by 48 and the outer peripheral side by 50. The two end faces 44, 46 of the sealing ring 10 can be designed to extend parallel to each other.

In the mounting state, the sealing edge 52 of the sealing ring 10 bears in a dynamically sealing manner on the sealing surface 40 of the first machine part 32. For an adequate contact pressure of the sealing edge 52 and the sealing surface 40, a rubber-elastically deformable preloading element 54 is used. The preloading element 54 bears peripherally on the periphery of the sealing ring 10 and loads the latter against the sealing surface 40. The preloading element 54 can be designed, for example, as a rubber ring or as a garter spring.

The first machine part 32 here has a run-on chamfer 56 at one end as a mounting aid. During the mounting of the system 200, the first machine part 32 is introduced into the second machine part 34 from the high-pressure side H longitudinally and coaxially to the movement axis 38, FIG. 4A. In chronological sequence, firstly a supporting structure 58 of the sealing ring 10 is contacted by the first machine part 32 before the latter contacts the sealing edge 52, FIG. 4B.

In a manner derived from the axial (insertion) movement of the first machine part 32, the sealing ring 10 is moved into the seal retaining structure 42 in a radial direction with deformation of the sealing ring 10 on the high-pressure side by the first machine part 32, so that a moment 60 acts on the sealing ring 10. In other words, the supporting structure 58 effects a moment acting in the radial direction, as a result of which the angle α (cf. FIG. 4a) is reduced while deforming the radial sealing ring 10 and the preloading element 54 (cf. FIG. 4c). At the same time, the radial sealing ring 10 and the first machine part 32 are centered relative to the central axis 16 or movement axis 38. Overall, during the mounting of the system 200, excessive loading of the sealing edge 52 and damage thereto can be counteracted as a result.

It is only during a further axial movement of the first machine part 32 into the second machine part 34 that according to FIG. 4C the sealing edge 52 is also contacted by the run-on chamfer 56 of the first machine part 32 and the sealing ring 30 is moved further into the sealed retaining structure 42 by the further axial movement of the first machine part 32, until the sealing edge contacts the sealing surface 40 of the first machine part (FIG. 4D) and, finally, the mounting state of the sealing system 200, shown in FIG. 4E, in the non-pressure-loaded state is achieved. Even here, the angle α reduced by the mounting still exists.

It should be noted that in the non-pressure-loaded mounting state of the system 200, the preloading element rests on the sealing ring 10 in such a way that an effective mid-plane 62 of the preloading element 54 is arranged to be offset relative to the sealing edge 52 of the sealing ring 10 in an axial direction toward the high-pressure side H of the sealing ring 10.

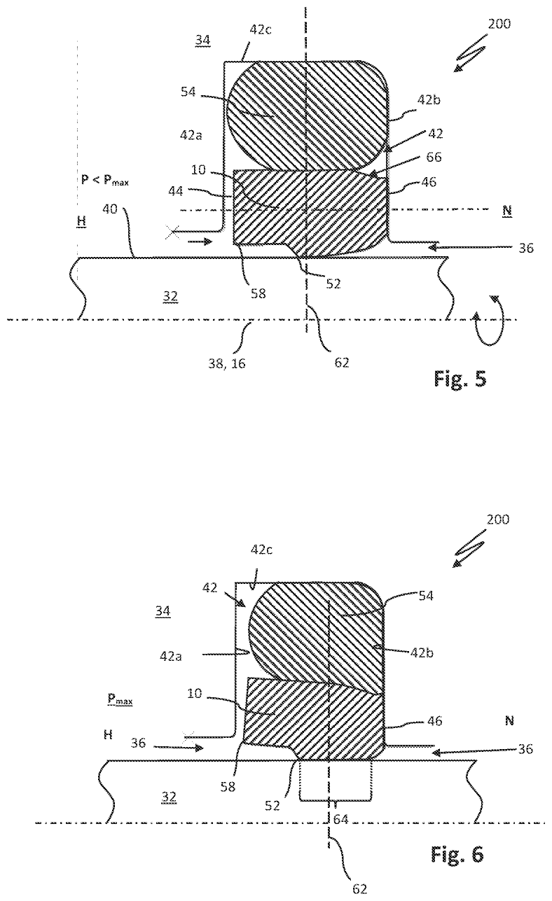

In FIG. 5, the sealing system 200 explained above in conjunction with FIGS. 4 is shown with an operating pressure P prevailing on the high-pressure side H, with
P=1 MPa.

FIG. 6 shows the sealing system 200 with a maximum operating pressure Pmax of 30 MPa, by way of example here, prevailing on the high-pressure side H.

According to FIGS. 5 and 6, when an operating pressure P is applied to the high-pressure side of the sealing gap 36, the effect is a displacement of the effective mid-plane 62 of the preloading element 54, which displacement is pressure-proportional to the operating pressure P, in an axial direction toward the low-pressure side N. Here, the angle α between the transverse axis 18 of the sealing ring 10 and the central axis 16 of the sealing ring 10 or the movement axis 38 is reduced further and can even experience a sign change. In other words, a parallel alignment of the transverse axis 18 relative to the central axis is achieved only in the installed operating state and when an operating pressure P is applied to the high-pressure side.

At the maximum operating pressure P^{max} (FIG. 6), the preloading element can be isovolumetrically deformed substantially in an axial direction toward the low-pressure side N and radially in the direction onto and against the sealing surface 40. The sealing ring 10 then bears peripherally on the sealing surface 40 with its sealing edge 52 and with a longitudinal segment 64 immediately adjacent to the sealing edge 52 on the low-pressure side. As a result, large-area support of the sealing ring 10 is made possible, by means of which undesired damage to the sealing edge 52 of the sealing ring 10 is counteracted even at a high system pressure. At the same time, the sealing gap 36 is closed over a long distance in an axial direction, which means that an adequate sealing action of the sealing ring 10 is ensured even at a maximum operating pressure Pmax.

The sealing ring 10 can also have an end section 66 on the low-pressure side (FIG. 5) which tapers (in section) at least partly (e.g. conically) toward the end face 46 on the low-pressure side. As a result, as the operating pressure P rises as far as the maximum operating pressure Pₘₐₓ, this benefits a radial deformation of the preloading element 54 radially in the direction of the sealing surface 40 and a tilting moment acting on the sealing ring 10.

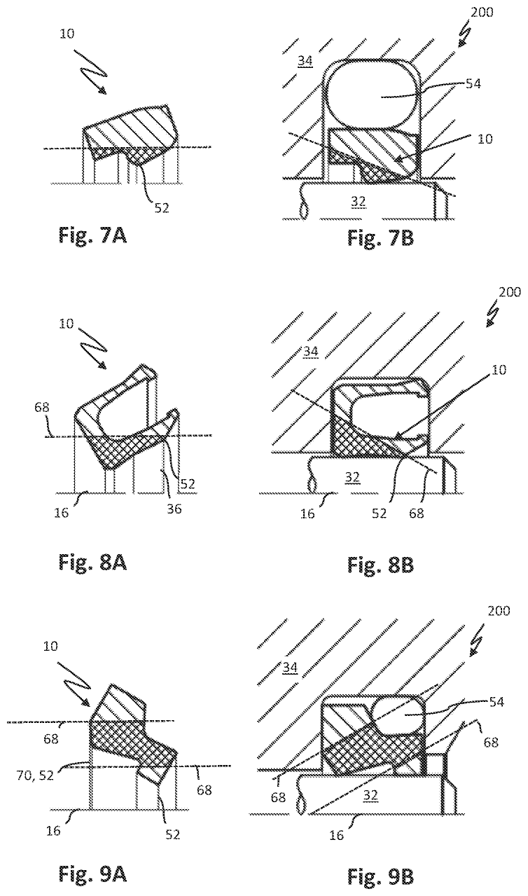

In FIGS. 7 to 9, sealing rings 10 are each shown in a cropped sectional view (FIG. 7A, 8A and 9A) and in the mounting state/in operational use (FIGS. 7B, 8B and 9B). The sealing rings 10 are each designed as multicomponent parts and cropped out of a longitudinal profile in the manner explained above.

In the unloaded state of the sealing rings 10, the dividing line 68 (cf. also FIG. 2) between the material layers of the sealing rings 10—in the longitudinal section of the radial seals 10—is arranged to extend parallel to the central axis. When the sealing rings 10 are completely mounted, this is in each case arranged to extend obliquely with respect to the central axis 16. This makes it possible to position a first material, for example with a good sealing and frictional performance, on the sealing edge, and to position a further material with, for example, a high resistance to the extrusion of the sealing rings 10 on the low-pressure side. As an additional or alternative advantage, this can be used to identify the front and rear side of the sealing rings 10 with a color and thus to improve the installation and testing routines.

The sealing ring 10 designed as a scraper according to FIGS. 9 has a three-layer structure. Here the scratching and sealing edge 70 is formed from a hard and mechanically robust material, while the dynamically sealing sealing edge 52 is formed from another material, for example with a good frictional behavior. Those regions which are in contact only with the preloading element or the seal retaining structure can be formed from an inexpensive material.

What is claimed is:

1. A method for producing a sealing ring from a longitudinal profile, comprising the following steps:
providing the longitudinal profile in the form of a tube or a rod;
three-dimensionally defining the sealing ring to be separated from the longitudinal profile in the material of the longitudinal profile with a transverse axis of the sealing ring (10) that extends at an angle α to the mid-axis of the longitudinal profile with 7°≤α≤90°; and
separating the sealing ring from the longitudinal profile by removing material;
wherein a multicomponent longitudinal profile which has layers that differ from one another in their material characteristics is provided as the longitudinal profile.

2. The method as claimed in claim 1, wherein the angle α is chosen between 10° und 45°.

3. The method as claimed in claim 1, wherein the angle α is chosen between 13° und 30°.

4. The method as claimed in claim 1, wherein the layers are arranged extending coaxially to the mid-axis of the multicomponent longitudinal profile.

5. The sealing ring for a pneumatic or a hydraulic system, having a sealing edge configured for dynamically contacting a sealing surface of a machine part, which sealing edge is closed in a ring shape relative to a central axis of the sealing ring, wherein the sealing ring in its unloaded state has, in a section comprising the central axis, a transverse axis which forms with the central axis the angle α with 7°≤α≤90°, wherein the sealing ring is produced according to the method of claim 1.
